(19) United States
(12) Patent Application Publication
(10) Pub. No.: US 2013/0124447 A1
(43) Pub. Date: May 16, 2013

(54) COGNITIVE RELEVANCE TARGETING IN A SOCIAL NETWORKING SYSTEM USING CONCEPTS INFERRED FROM EXPLICIT INFORMATION

(71) Applicants: Gregory Joseph Badros, Palo Alto, CA (US); Rajat Raina, Mountain View, CA (US); Ding Zhou, Palo Alto, CA (US); Tudor Andrei Alexandrescu, Houston, TX (US); Nuwan Senaratna, Sunnyvale, CA (US); Hong Ge, Cupertino, CA (US); Chi Wang, Urbana, IL (US); Alon Amit, Los Altos, CA (US); John Hegeman, Palo Alto, CA (US)

(72) Inventors: Gregory Joseph Badros, Palo Alto, CA (US); Rajat Raina, Mountain View, CA (US); Ding Zhou, Palo Alto, CA (US); Tudor Andrei Alexandrescu, Houston, TX (US); Nuwan Senaratna, Sunnyvale, CA (US); Hong Ge, Cupertino, CA (US); Chi Wang, Urbana, IL (US); Alon Amit, Los Altos, CA (US); John Hegeman, Palo Alto, CA (US)

(21) Appl. No.: 13/296,117

(22) Filed: Nov. 14, 2011

(51) Int. Cl. G06N 7/02; G06N 5/04; G06Q 30/02; G06N 5/00

(52) U.S. Cl. 706/52; 706/45; 705/14.53

(57) ABSTRACT

A social networking system infers a user's present interests based on the user's recent actions and/or the recent actions of the user's connections in the social networking system. The social networking system also determines a set of concepts associated with each of a set of information items, such as advertisements. By matching the user's present interests with the concepts associated with the information items, the social networking system selects one or more of the information items that are likely to be of present interest to the user. At least one of the matched interests and concepts are not identical. The social networking system then presents the selected information items for display to the user, thereby providing information based on an inferred temporal relevance of that information to the user.

### CROSS REFERENCE TO RELATED APPLICATIONS

This application is related to application Ser. No. 13/095,899, filed Apr. 28, 2011, which is incorporated by reference in its entirety.

### BACKGROUND

This invention relates generally to social networking, and in particular to providing information items, including advertisements, to users of a social networking system.

Social networking systems allow users to connect to and form relationships with other users, contribute and interact with media items, use applications, join groups, list and confirm attendance at events, create pages, and perform various other tasks that facilitate social interaction. A social networking system therefore provides information to its users in a number of different contexts. For example, a social networking system may provide updates about the actions of a user's connections (i.e., a newsfeed story), search results, content recommendations, and a variety of other types of information items. Typically, the social networking system selects one or more information items from a larger set of candidate information items for display to a user. For example, a social networking system may present advertisements to a user by selecting one or more advertisements for the user based on targeting criteria associated with the advertisements and on various attributes of the user.

One difficulty facing social networking systems is determining information items that are most relevant to a user's current interests when concepts associated with the information items do not exactly match the user's current interests. As a result, users are often exposed to advertisements and other information items that are less relevant to the user's interests, and these information items will thus tend to receive less of the user's attention. For advertisements, this results in lower conversion rates and thus less advertising revenue. Similarly, other information items such as newsfeed updates that are less interesting or relevant to a user lead to a less optimal user experience that fails to maximize user engagement with the social networking system.

### SUMMARY

To provide more relevant information items (such as advertisements) to a user of a social networking system, embodiments of the invention select information for display to the user based on the inferred temporal relevance of that information to the user. In one embodiment, a social networking system infers a user's current interests based on the user's recent actions and/or the recent actions of the user's connections. The social networking system also determines a set of concepts associated with one or more of a set of information items. By matching the user's current interests with the concepts associated with the information items, the social networking system selects one or more of the information items that are likely to be of present interest to the user. At least one of the matched interests and concepts may not be identical. For example, an information item related to snowboarding may be presented to a user based on the user's interest in skiing. The social networking system then presents the selected information items for display to the user.

In one embodiment, the social networking system infers a user's current interests by extracting a set of concepts from the user's recent actions, and optionally from the recent actions of the user's connections. These concepts are then weighted (or discounted) based on a number of factors, which may include the time since the action was performed, the type of the action, whether the action was performed by the user or the user's connection (and if so, the closeness of the connection), and how closely in a taxonomy the concept matches a tag word or label associated with the action. In this context, more recent actions are typically given greater importance, and different actions may be weighted differently. For example, a user's commenting on a news story may initially be given more importance than the user's joining a group, but the action of commenting may decay more quickly than the joining of the group. The taxonomy enables the system to infer additional interests from a smaller set of labels, but these are generally discounted as the words are further apart in the taxonomy. For example, if a user checks in at a Starbucks, the system may infer the concept of “Starbucks” as one interest and the concept of “coffee” as another interest, but one that is discounted due to its distance from the original “Starbucks” label associated with the check-in action.

Similarly, the social networking system may weight (or discount) the concepts that it determines for each of the information items. These concepts may be obtained from tag words and other metadata associated with the information items, as well as from the content of the information items themselves. For an advertisement, for example, the concepts may include tag words, targeting criteria, advertisement content, and the content of pages pointed to by links in the advertisement. The set of concepts determined for an information item may be expanded by reference to a taxonomy in which additional concepts related to the identified concepts are added to the set. As above, these additional inferred concepts from the taxonomy may be discounted based on their distance from the originally identified concepts.

The information items may comprise advertisements, wherein embodiments of the invention are used to provide temporally relevant advertising to a user. In other embodiments, the information items may include newsfeed stories, notifications, invitations, or any other type of information that may be selected for presentation to a user of an online system. Embodiments of the invention may have a particular utility in a social networking system, which may leverage its knowledge about the actions of the user's connections to infer additional information about the user's current interests. However, other embodiments need not use information about a user's connections and may thus be useful in other types of online systems that select information for presentation to a user.

### BRIEF DESCRIPTION OF THE DRAWINGS

FIG. 1 is a diagram of a process for targeting information items to users of a social networking system, in accordance with an embodiment of the invention.

FIG. 2 is a diagram of the overall system environment for targeting information items to users of a social networking system, in accordance with an embodiment of the invention.

FIG. 3 depicts an example taxonomy used by the action interest extractor and information item concept extractor.

FIG. 4 is a table of a set of example concepts and their associated discount factors for representing a user's inferred interests, in accordance with an embodiment of the invention.

FIG. 5 is an example of an advertisement in a social networking system, in accordance with an embodiment of the invention.

FIG. 6 is a table of a set of example concepts and their associated cumulative discount factors determined for an advertisement information item, in accordance with an embodiment of the invention.

FIG. 7 illustrates a process for selecting matched interests and concepts, in accordance with an embodiment of the invention.

FIG. 8 illustrates a process for targeting advertisements to a user based on the inferred temporal relevance of the advertisements to the user's current interests, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview of Process for Targeting Based on Contextual Relevance

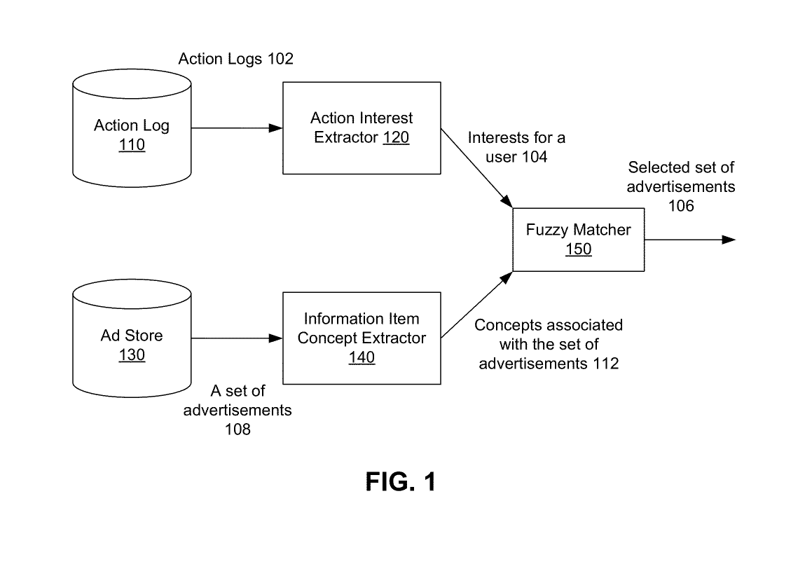

FIG. 1 is a high level diagram of a process for targeting information items to users of a social networking system based on the inferred temporal relevance of the advertisements to the user's current interests. These information items may include advertisements, newsfeed stories, notifications, invitations, polls, suggested action, media item, or any other type of information that may be selected for presentation to a user of an online system. In the example of FIG. 1, the information items comprise advertisements stored in the ad store 130.

The action log database 110 stores a log of actions 112 of a user and those of other users with whom the user has established a connection in the social networking system (i.e., the user's connections). A log entry for an action may include the time of occurrence of the action, a type of action performed, the user who performed the action, users referenced or mentioned by the action, an object on which the action was performed, and any other information related to the action, such as the content of a user's comment or a location associated with the action. For example, in the action ‘Adrian bought a ring at Tiffany & Co.,’ the type of action is buying, the object is a ring and extra information includes where the ring was bought, Tiffany & Co. The actions may be taken online either within the social networking system or outside of it, or they may be actions performed in the real world and recorded and communicated to the social networking system. The action log database 110 provides the logs of actions 102 to the action interest extractor 120.

The action interest extractor 120 extracts interests for each of the actions and weights or discounts the actions based in part on a time associated with the actions. An extracted interest may be expressed as a term that describes information about the action. For example, for the action ‘Charlie joined the group SF Foodies,’ the action interest extractor 120 may extract interests such as “food,” “cooking,” and “San Francisco,” since these terms reflect information about the action. Moreover, the weighting (or discounting) of these interests enables the system to assign more meaning to certain interests. For example, interests associated with more recent actions may be weighted higher because they are more likely to represent the user's current state of mind, and interests associated with actions performed by the user may be weighted more heavily than interests associated with actions performed by the user's friends. In one embodiment, the action interest extractor 120 may extract information describing user actions as the user performs the actions, for example, as the user interacts with the social networking system via a client device. Alternatively, the action interest extractor 120 may extract information describing past user actions stored in action logs 110 as an offline operation. It can be appreciated that the extracted interests and their weights will change over time, just as a user's current interests can change. The action interest extractor 120 provides the extracted weighted interests 104 to the fuzzy matcher 150.

The ad store 130 stores or otherwise has access to a plurality of advertisements or advertising items. Each advertisement may include content (such as a title, text, video, image, and a link) and may be associated with metadata such as targeting criteria. The targeting criteria may include any information that can be used to identify a user. For example, targeting criteria may include age, gender, income, geographic location, education, wealth, religion, race, ethic group, marital status, household size, employment status, and political party affiliation. Targeting criteria for an advertisement represents the advertisers desired audience for the advertisement. The ad store provides these candidate advertisements and their associated metadata to an information item concept extractor 140, which then extracts concepts that represent each of these advertisements. As with the concepts extracted from the action logs 102, the concepts extracted from each advertisement reflect information about the advertisement. For advertisements, for example, the information item concept extractor 140 may extract concepts based on the content of the advertisement, its targeting criteria, and/or information contained within a page or other content item associated with a link in the advertisement. For example, an advertisement that mentions a restaurant and contains a link to the restaurant's web page, the extracted concepts for the advertisement may include the name of the restaurant and the style of food mentioned in the web page. The information item concept extractor 140 then provides the concepts for each of a set of advertisement 112 to the fuzzy matcher 150.

Using the set of interests 104 that describe the user's current state of mind and the sets of concepts 112 that describe each candidate advertisement, the fuzzy matcher 150 attempts to select one or more advertisements that best matches the user's current interests. In one embodiment, the fuzzy matcher 150 takes the action interests and the information item concepts as inputs and then outputs a set of features that can be used in CTR prediction and ranking for a system that selects content items for a user (such as an ad server). By providing better targeted and more relevant information items to a user, the provided information may enhance the user's experience and will be less likely to annoy the user as a distraction.

### Overview of Social Networking System

A social networking system allows users to associate themselves and establish links or connections with other users of the social networking system. When two users become linked, they are said to be “connections,” “friends,” “contacts,” or “associates” within the context of the social networking system. In general, being linked in a social networking system allows linked users access to more information about each other than would otherwise be available to unlinked users. The social networking system provides a user with various ways to communicate with other users, for example, by email (internal and external to the social networking system), instant message, text message, voice, video chat, and the like. The social networking system allows a user to introduce new content items as well as to view, comment on, download or endorse another user's content items. Examples of content items include but are not limited to messages, queued messages (e.g., email), text and SMS (short message service) messages, comments, messages sent using any other suitable messaging technique, an HTTP link, HTML files, images, videos, audio clips, documents, document edits, calendar entries or events, and other computer-related files.

Users of social networking systems may interact with objects such as content items, user profile information, user actions, or any other action or data within the social networking system. This interaction may take a variety of forms, such as by communicating with or commenting on the object; clicking a button or link associated with affinity (such as a “like” button); sharing a content item, user information or user actions with other users; or downloading or viewing a content item. Users of a social networking system may also interact with other users by connecting or becoming friends with them, by communicating with them, or by having common connections within the social networking system. Further, a user of a social networking system may form or join groups or may like a page (i.e., to express an interest in a page or other non-user entity). Finally, a social networking system user may interact with content items, websites, other users or other information outside of the context of the social networking system's web pages that are connected to or associated with the social networking system. For instance, an article on a news web site might have a “like” button that users of the social networking system may click on to express approval of the article. These interactions and any other suitable actions within the context of a social networking system are recorded in social networking system data or action log, which may be used to display targeted and relevant information items that the user is more likely to act on, by say clicking on them.

The social networking system maintains a user profile for each user. Any action that a particular user takes with respect to another user is associated with each user's profile, through information maintained in a database or other data repository. Such actions may include, for example, adding a link to the other user, sending a message to the other user, reading a message from the other user, viewing content associated with the other user, attending an event posted by another user, among others. The user profiles also describe characteristics, such as work experience, educational history, hobbies or preferences, location or similar data, of various users and include data describing one or more relationships between users, such as data indicating users having similar or common work experience, hobbies or educational history. Users may also post messages specifically to their profiles in the form of “status updates.” Users of a social networking system may view the profiles of other users if they have the permission. In some embodiments, becoming a connection of a user automatically provides the permission to view the user's profile.

The social networking system also attempts to deliver the most relevant information items to a viewing user employing algorithms to filter the raw content on the network. Content is filtered based on the attributes in a user's profile, such as geographic location, employer, job type, age, music preferences, interests, or other attributes. A “newsfeed” is a collection of updates visible to a user. Newsfeed stories may be generated to deliver the most relevant information to a user based on a ranking of the generated content, filtered by the user's affinity, or attributes. Similarly, “social endorsement” information may be used to provide social context for advertisements that are shown to a particular viewing user.

The social networking system also provides application developers with the ability to create applications that extend the functionality of the social networking system to provide new ways for users to interact with each other. For example, an application may provide an interesting way for a user to communicate with other users, or allow users to participate in multi-player games, or collect some interesting information such as news related to a specific topic and display it to the user periodically. The social networking system acts as a platform for the applications. Some of the applications may reside on an external server and may be hosted by a third party.

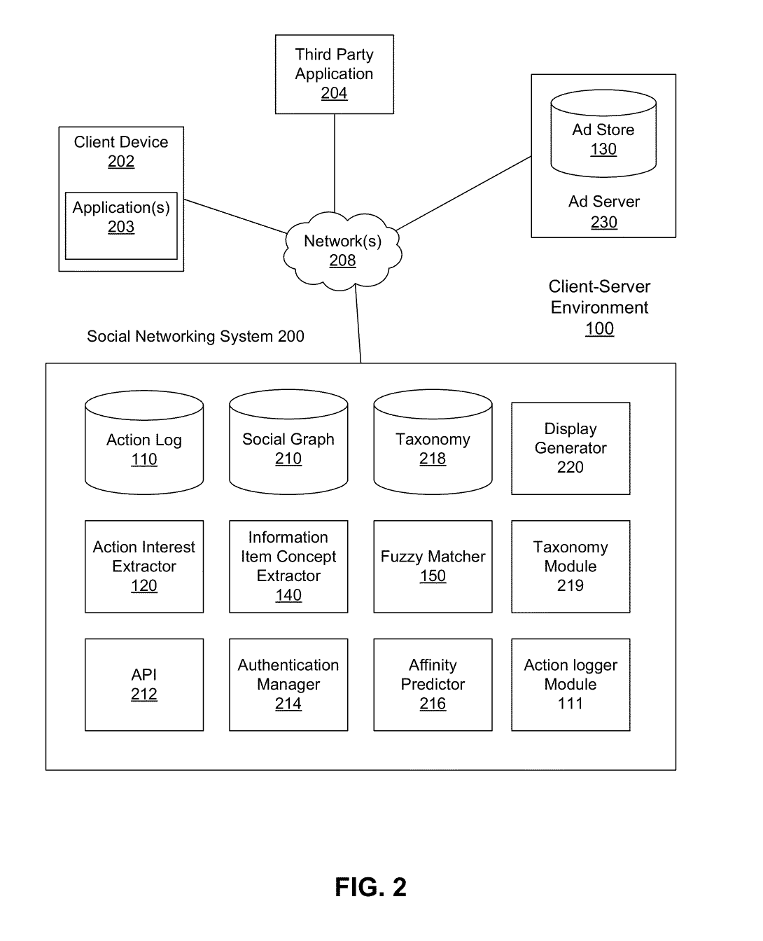

FIG. 2 is a high-level block diagram a distributed system 100 of a social networking system according to one embodiment. FIG. 2 illustrates a social networking system 200, a client device 202, a third party application 204 and ad server 230 connected by a network 208. The ad server 230 hosts the ad store database 130 previously described.

In some embodiments, the social networking system 200 is implemented as a single server, while in other embodiments it is implemented as a distributed system of multiple servers. Solely for convenience of explanation, social networking system 200 is described below as being implemented on a single server system.

The communication network(s) 208 can be any wired or wireless local area network (LAN) and/or wide area network (WAN), such as an intranet, an extranet, or the Internet. It is sufficient that the communication network 204 provides communication capability between the client device 202, the social networking system 200 and the ad server 230. In some embodiments, the communication network 104 uses the HyperText Transport Protocol (HTTP) and the Transmission Control Protocol/Internet Protocol (TCP/IP) to transmit information between devices or systems. HTTP permits client device 202 to access various resources available via the communication network 208. The various embodiments of the invention, however, are not limited to the use of any particular protocol.

A user interacts with the social networking system 200 using a client device 202, which may be any suitable computer device that is capable of connecting to the social networking system 200 via communication network 208, such as a computer, a desktop computer, a laptop computer, a tablet device, a netbook, an internet kiosk, a personal digital assistants, a mobile phone and a gaming device. The client device 202 may communicate with the social networking system 200 via an application 203 such as a web browser or native application. Typical interactions between the client device 202 and the social networking system 200 include operations such as viewing profiles of other users of the social networking system 200, sending messages to other users, contributing and interacting with media items, joining groups, listing and confirming attendance at events, checking in at locations, liking certain pages, creating pages, and performing other tasks that facilitate social interaction.

The third party application 204, which is an application residing on an external server, may comprise a service running on a web server or an application on a mobile device. Additionally, the third party application 204 may interact with the social networking system 200 via a system-provided application programming interface (API) 212. For example, a third party website may perform operations supported by the API, such as enabling users to send each other messages through the social networking system 200 or showing advertisements routed through the social networking system 200.

The ad server 230 resides outside the social networking system 200 in the embodiment of FIG. 2. However, the ad server 230 may reside within the social networking system 200 in other embodiments. The ad store database 130 within the ad server 230 stores advertisements aimed at users of the social networking system 200 or the third party application 204. The advertisements may be associated with targeting criteria that the ad server 230 uses to determine an eligible set of advertisements for a given user with specified demographic information. For example, the targeting criteria may specify single marital status, a high income range, and an age range in the twenties for targeting an advertisement of men's health magazines.

The social networking system includes an authentication manager 214 that authenticates a user of client device 202 as belonging to the social graph on the social networking system 200. In some embodiments, the authentication manager 214 stores user account information (e.g., username and password) for each user in the social networking system 200. In some embodiments, the API 212 works in conjunction with the authentication manager 214 to validate users using the third party application 204.

The social networking system 200 further includes a social graph database 210. The social graph database 210 stores a social graph which represents a global mapping of all of the users in the social networking system 200 and how they are related. The social graph stores the connections that each user has with other users of the social networking system 200. The social graph may also store second order connections, in some embodiments. If user A is a first-order connection of user B, and B is a first-order connection of C, then C is a second-order connection of A on the social graph 210.

The social networking system 200 also includes an action log database 110 which stores action logs. As discussed above, action logs stores information about actions that the users of the social networking system 200 have performed. A separate action log may be stored for each user of the social networking system 200. Action logs are stored in the action log database 110 by an action logger module 111 which monitors user actions.

The social networking system 220 includes a display generator 220 that generates display pages to display to users. For example, the display generator 220 may generate a profile page of a user. In some embodiments, the display generator 220 inserts a set of information items into a display page and sends the display page to a user.

The social networking system 200 also includes an affinity predictor 216, which uses information from the social graph stored in the social graph database 210 to determine affinity between the user and the user's connections. The relationship of a connection with a user may be determined based on multiple factors, including the number and/or nature of interactions between a user and a connection and any common elements in the profiles of the user and the connection. For example, a user and a connection that interact once every week on average, as opposed to every month on average, are judged to have a stronger relationship. Similarly, if a user and a connection exchange private messages, they are judged to have a stronger relationship than if they were to exchange public messages. Additionally, if the connection and the user went to the same school, for example, as determined from the profiles of the user and the connection, the connection and the user are determined to have a strong relationship.

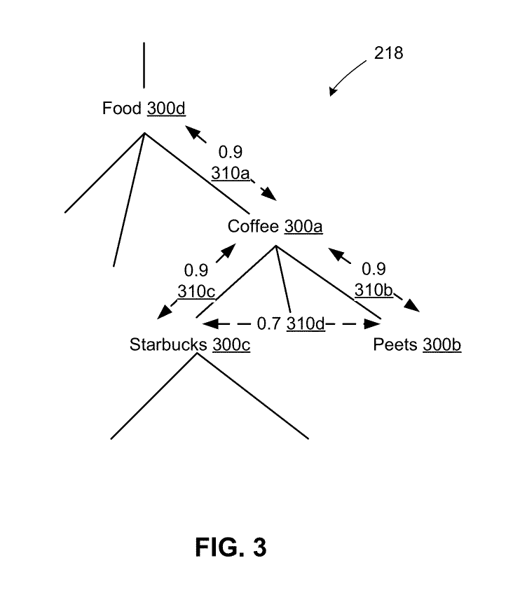

The social networking system 200 includes a taxonomy database 218 that stores a taxonomy which is a hierarchical arrangement of terms (which may include interests and/or concepts) and the relationships between the terms. FIG. 3 depicts an example taxonomy that may be used by the action interest extractor 120 and information item concept extractor 140. For the purpose of the taxonomy, a term refers to an entity 300 in the hierarchical arrangement. In the example shown in FIG. 3, the entities are Coffee 300a, Peets 300b, Starbucks 300c, and Food 300d.

The taxonomy module 219 takes an interest or concept as input and provides a number of related interests or concepts from a hierarchal arrangement (i.e., the taxonomy) stored in the taxonomy database 218. In one embodiment, the related interests or concepts may comprise the immediate parent, child or sibling entities 300 in the hierarchical arrangement. As an example, when taxonomy 218 receives ‘Starbucks’ as an input interest or concept, it first locates ‘Starbucks’ in the hierarchal arrangement and provides related interests or concepts. In the example, the related interest or concepts for ‘Starbucks’, may be ‘Food’, ‘Peets’ and ‘Coffee.’ Additionally, the discount factor associated with one term may be higher for terms that are higher in the hierarchical arrangement in the taxonomy. This reflects the increased stability of terms that are higher in the hierarchical arrangement in the taxonomy as indicators of the user's interest. For example, the higher interest of coffee may be a stable interest whereas the lower specific interest of Peets may be a transient interest.

The taxonomy module 219 may also provide a relatedness factor 310 associated with each additional concept or additional interest it provides as output. The relatedness factor is a measure of how closely the additional concept or additional interest is related to the input concept or interest. In the example discussed earlier, the relatedness factors are Food to Coffee 310a of 0.9, Coffee to Peets 310b of 0.9, Coffee to Starbucks 310c of 0.9 and Starbucks to Peets 310d of 0.7. The relatedness factors between entities not directly connected in the hierarchy may be computed from the relatedness factors between entities connecting them. For example, in an embodiment of the invention, the relatedness factor 310 for Starbucks to Food is computed by multiplying the relatedness factors for Food to Coffee 310a and Coffee to Starbucks 310c. Additionally, in some embodiments, the taxonomies may be sparse. Intermediate entities in the hierarchal arrangement might be missing because they are not relevant.

The social networking system 200 further comprises the action interest extractor 120, mentioned above. The action interest extractor 120 accesses the action logs stored in the action log database 110 and determines a set of interests and a weighting associated with each interest derived from the logged actions. The weighting or discount factors for a given interest indicate the strength of that interest. The interests and weights represent a user's current interests. The weighting may be a product of several factors. For example, the weighting may be derived from a set of discount factors that are based on a decay representative of the time associated with the action, a type of action performed, the user or connection who performed the action, one or more interests extracted based on the object on which the action was performed, and additional information related to the action (e.g., the content of a user's comment or a location). The action interest extractor 120 determines a cumulative discount factor for each determined interest based on each of these factors.

In the embodiment described above, a discount factor corresponding to a decay representative of the time associated with the action is used to provide temporal relevance for targeting information items. Some embodiments employ the approach of accounting for the actions in specific windows of time, and discounting or weighing the windows differently. For example, actions in the last 30 days may be associated with a discount factor of 0.5 while actions in the last 90 days may be associated with a discount factor of 0.25. Additionally, different actions on an object might indicate different levels of affinity (or lack thereof). Joining a group associated with an object might indicate a higher factor than merely “liking” the same object. Similarly, “leaving” a page might indicate a low discount factor.

The action interest extractor 120 may consult the taxonomy stored in the taxonomy database 218 to obtain additional interests associated with a determined extracted interest. Thus, the action interest extractor 120 may infer additional interests for a user that were not extracted from the user's actions. The taxonomy thus enables the action interest extractor 120 to obtain more interests associated with a user's current state of mind, thereby increasing the effectiveness of the fuzzy matcher 150. However, the additional inferred interests obtained using the taxonomy may be discounted more as their meaning departs from the originally extracted interest. For example, the action interest extractor 120 may infer from an interest of skiing that a user is also interested in snowboarding. The interest of snowboarding may be discounted based on its distance from skiing in the taxonomy.

In some embodiments, the action interest extractor 120 extracts interests from the logged actions of the connections of a user in addition to those of the user. The action interest extractor 120 may consult the affinity predictor 216 to determine a friend factor discount based on the rank or closeness of a relationship. As the connection of a user becomes more distant, the extracted interests associated with that connection's action may be discounted more heavily.

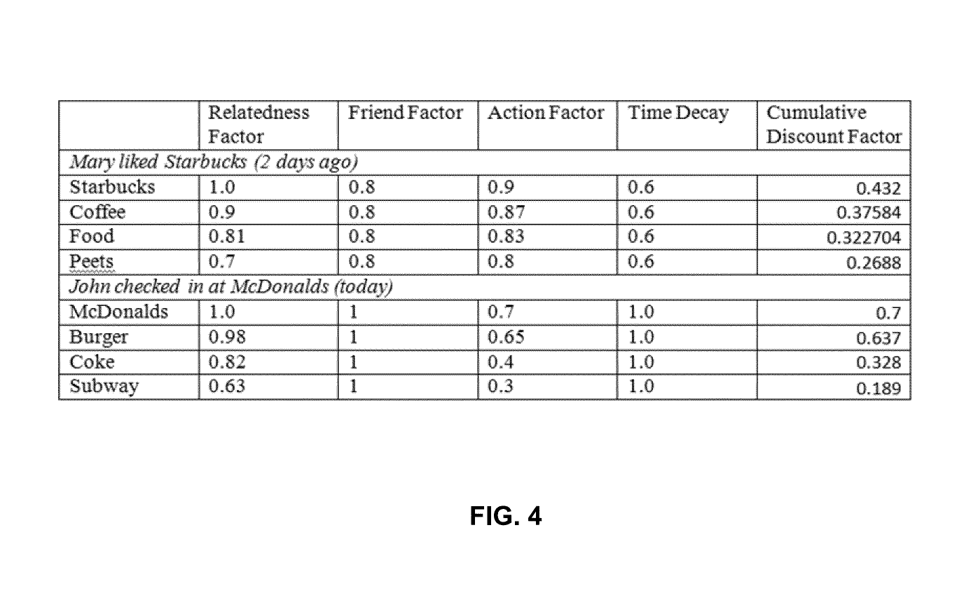

FIG. 4 is a table of a set of example interests and their associated cumulative discount factors determined for representing a user's inferred interests. In FIG. 4, John is the user of the social networking system 200 for whom the action interest extractor 120 is applied. The action interest extractor 120 analyzes an action of Mary, who is a connection of John, where the action “Mary liked Starbucks” occurred two days ago. In this example, Mary is a reasonably strong connection of John; hence, the action interest extractor 120 determines a friend factor of 0.8 for her action. It also determines that a time decay factor of 0.6. Using the taxonomy module 219, action interest extractor 120 determines that there are four additional interests—Starbucks, Coffee, Food, and Peets—with associated relatedness factors. For each interest, an action factor is assigned, based on the type of action, which in the example of FIG. 4 is “liked,” and its relevance to the interest. In some embodiments, the friend factor and time decay may also be determined differently for each interest. Based on the factors, a cumulative discount factor is determined for each interest. In one embodiment, the cumulative discount factor for an interest is obtained by multiplying the relatedness factor, action factor, friend factor, and time decay factor for the interest. A similar process may be carried for the second example in FIG. 4 for the action, “John checked in at McDonalds.” In this example, the friend factor is set to unity (i.e., no discounting) because it is the user himself who performed the action as opposed to a connection of the user.

The action interest extractor 120 may be modified in other embodiments of the invention that provide targeting for other information items, such as updates for a user's newsfeed. For example, in an embodiment, the action interest extractor 120 may not extract interests from the actions of the connections of a user as described in the newsfeed.

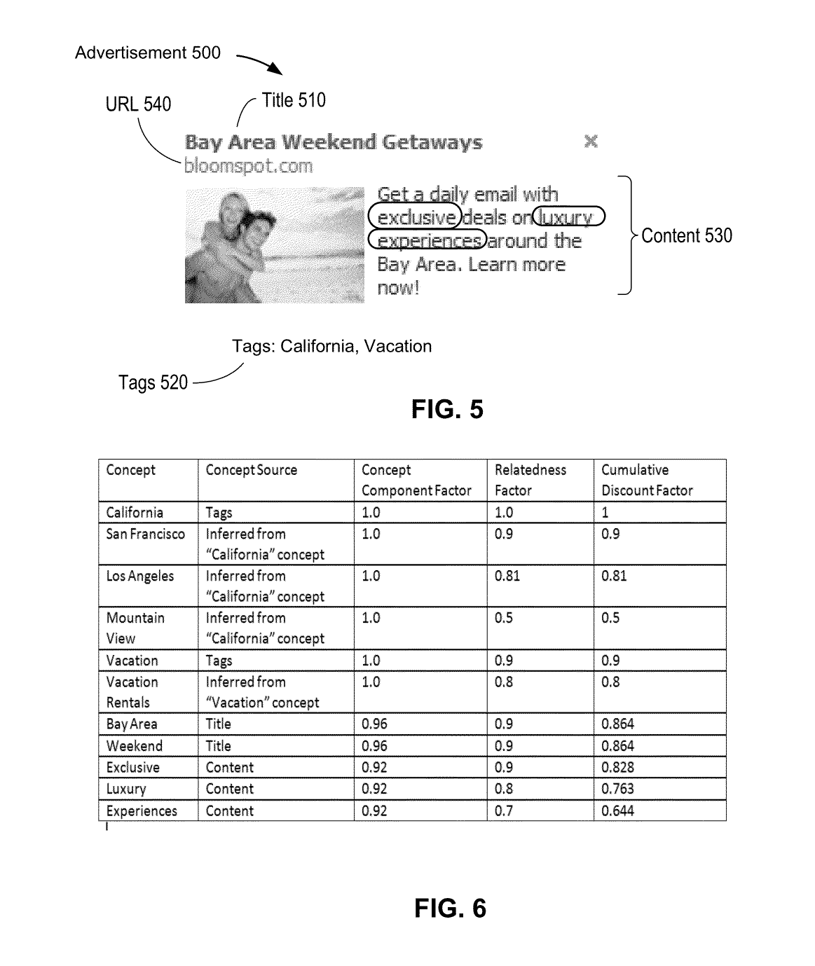

The information item concept extractor 140 uses a similar process to obtain concepts for each of a set of information items and weightings associated with each concept. The information items comprise advertisements in the examples above, and FIG. 5 illustrates an example of a typical advertisement 500. An advertisement may have multiple components from which to extract concepts. In the embodiment of FIG. 5, the components of advertisement 500 comprise the title of the advertisement 510, tags associated with the advertisement 520, content of the advertisement 530, and a URL linked to by the advertisement 540. Other embodiments may have more or fewer components or components similar to those shown in FIG. 5.

In the example of FIG. 5, the concepts extracted from the title 510 of the advertisement are “Bay Area” and “Weekend”. Likewise, the concepts extracted from the content 530 of the advertisement are “exclusive”, “luxury”, and “experiences.” Finally, the concepts extracted from the tags 520 associated with the advertisement are “California” and “Vacation.” Additional concepts may be extracted from the URL linked to by the advertisement, and more concepts may be extracted from the page linked to by the URL. Lastly, these concepts may be expanded upon using a taxonomy module 219, as described above.

FIG. 6 is a table of a set of example concepts and their associated cumulative discount factors determined for the advertisement information item 500 shown in FIG. 5. For each extracted concept, the information item concept extractor 140 computes a concept component factor based on the component from which the concept was derived. For example, the title component of an advertisement may have a higher concept component factor than the content of the advertisement. The concept component factor is applied to the additional concepts related to the concept. For example, the concept of San Francisco may be inferred based on the extracted concept of California and the same component factor that is applied to the concept of California is applied to San Francisco.

The information item concept extractor 140 may also consult the taxonomy module 219 to determine additional concepts related to the concepts derived from the advertisement and a relatedness factor associated with each additional concept. For example, as discussed above, the concept of San Francisco may be inferred based on the extracted concept of California. The relatedness factor for the inferred concepts may be determined based on the distance of the inferred concept from the extracted concept in the taxonomy.

The information item concept extractor 140 computers a cumulative discount factor for each concept based on the factors applied to the concepts. In some embodiments, the information item concept extractor 140 computes a cumulative discount factor based on the concept source factor and the relatedness factor associated with each concept and inferred concept. In the embodiment of FIG. 6, the cumulative discount factor is obtained by multiplying the concept source factor and the relatedness factor in each case.

The information item concept extractor 140 described above may also be used with modification in other embodiments of the invention for extracting concepts from other information items such as updates for a user's newsfeed. In the specific case of the information items being the updates for a user's newsfeed, the information item concept extractor 140 implements aspects of the action interest extractor 120 and extracts concepts from the actions of the connections of the user.

The social networking system 200 further includes a fuzzy matcher 150 that implements an information item scoring method 700 for deciding the best fit between a user and a number of information items given the cumulative discount factors assigned to the user's interests and concepts for each of the information items. In one embodiment, the fuzzy matcher 150 computes a score for each information item based on matching related interests and concepts from the information items and interests for the user. An interest and a concept may be matched if they are within a predefined distance of each other in a taxonomy. Stated in another way, a concept and an interest may be matched if they are sufficiently related to each other. Thus, an interest does not need to be identical to a concept in order for there to be a match. The step of matching may be implemented by multiplying the corresponding cumulative discount factor for the overlapping interests and concepts and adding the result to obtain a score for the information item. The fuzzy matcher 150 selects the information items with the highest scores to send to a user.

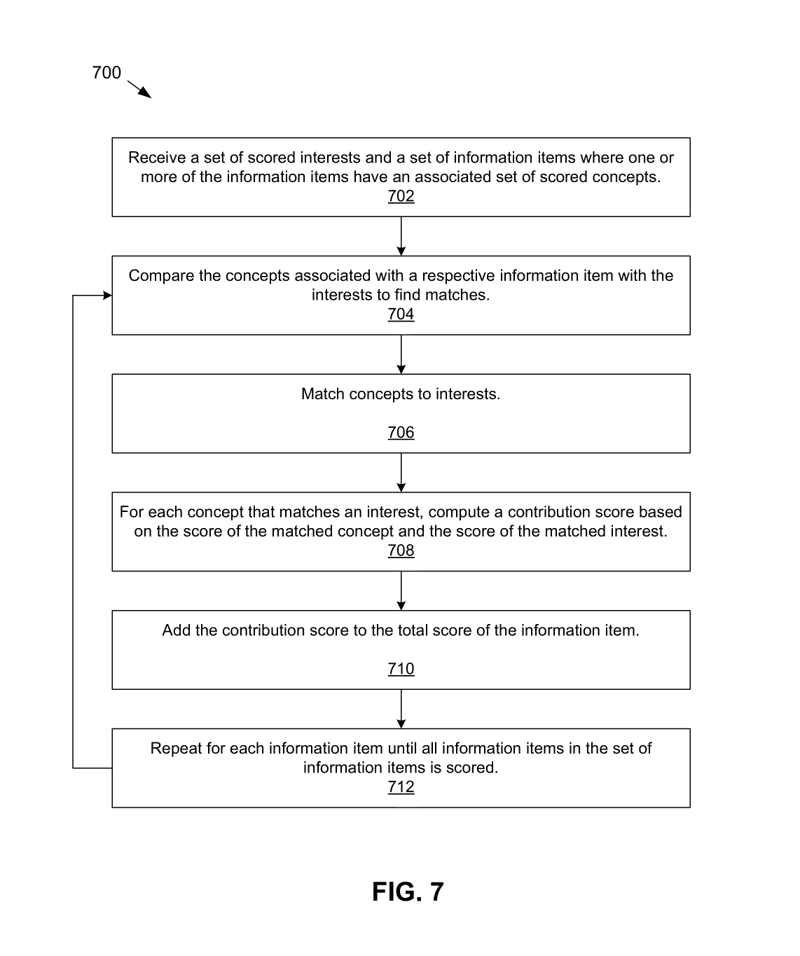

FIG. 7 illustrates the information item scoring process method 700 performed by the fuzzy matcher 150. The fuzzy matcher 150 receives 702 a set of scored interests and a set of information items where one or more of the information items have an associated set of scored concepts. In the context of FIG. 7, the score of an interest is the cumulative discount factor of the interest and the score of a concept is the cumulative discount factor of the concept. The set of concepts associated with a respective information item is compared 704 with the set of interests to find matches. Concepts and interests are matched 706. In some embodiments, a concept and an interest are matched if they are the closest pair within a predefined distance of each other in a taxonomy. The fuzzy matcher 150 determines the distances between the interests and the concepts in a taxonomy, determines which interests and concepts pairs are within a predefined distance of each other, and matches the closest pairs of interests and concepts that are within a predefined distance of each other. In some embodiments, a concept and an interest are matched based on a relatedness factor between the two terms. The terms having the highest relatedness factor above a minimum threshold are matched. As discussed above, the taxonomy module takes a term as input and provides a number of related terms and relatedness factors for each term. The relatedness factor for each term measures how related each term is to the input term. Thus, a concept does not need to be identical to an interest to be matched to the interest. For example, the fuzzy matcher 150 may match a concept of snowboarding to an interest of skiing even though the two terms are not identical. As a result, a user may be recommended an information item related to snowboarding even though the user has not expressly indicated an interest in snowboarding.

A contribution score is computed 708 for each matching concept and interest based on the score of the interest and the score of the concept. In some embodiments, the matched concept is discounted based on the distance between the concept and the interest in a taxonomy. In some embodiments, the matched concept is discounted based on the relatedness factor between the concept and the interest. It is noted that a match of a concept and an interest that are identical match would have little or no discount. The step of matching may be implemented by multiplying the score for interest and the score for the matching concept. For example, if a user has an interest in skiing with a score of 0.5 and the concept of skiing has a score of 1.0, the contribution score is the product of the two scores (i.e., 0.5 multiplied by 1.0).

In some embodiments, the set of interests discussed above includes a set of inferred additional interests. The fuzzy matcher 150 uses the action interest extractor 120 to infer one or more additional interests from the set of interests. In some embodiments, a respective additional interest is discounted based on a relatedness factor associated with the additional interest. In some embodiments, a respective additional interest is discounted based on a distance in the taxonomy between the respective additional interest and the interest from which the additional interest is determined from.

In some embodiments, the set of concepts for each of the information items includes one or more additional concepts. The fuzzy matcher 150 uses the information item concept extractor 140 to infer one or more additional concepts for the set of concepts for each information item. In some embodiments, a respective additional concept is discounted based on a relatedness factor associated with the additional concept. The respective additional concept may be discounted based on a distance in the taxonomy between the respective additional concept and the concept from which the additional concept is determined from.

The contribution score is added 710 to a total score for the corresponding information item. The comparing is repeated 712 for each information item until the set of information items is scored. The fuzzy matcher 150 selects one or more of the scored information items to display to a user.

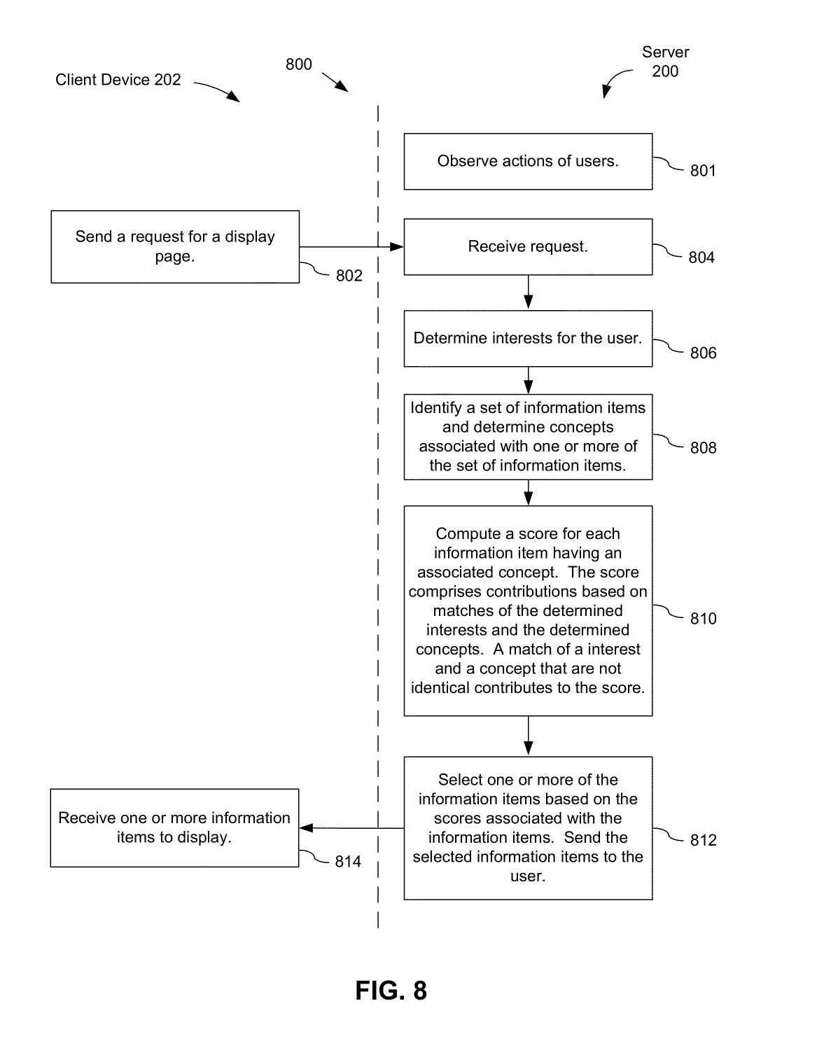

FIG. 8 illustrates a process 800 for targeting advertisements to a user based on the inferred temporal relevance of the advertisements to the user's current interests. A similar process may apply to targeting other information items such as updates for the newsfeed displayed to the user. Process 800 is performed at a server system having one or more processors and non-transitory memory.

The action logger module 111 of the social networking system 200 observes 801 the actions of a user and stores information about the actions in an action log. The user sends 802 a request for a display page to the social networking system 200 using a client device 202. For example, the user may request the profile page of another user, a page of a group, a photo album or the user's own profile page. The social networking system 200 receives 804 the user's request for a display page.

The action interest extractor 120 determines 806 interests for the user identified by the request. To determine the user's interests, the action interest extractor 120 accesses one or more action logs that are associated with the user in the action log database 110 and determines the user's interests based at least in part on the information in the logs about the user's actions. In other words, the action interest extractor 120 determines the user's interests based on the user's observed actions. To ensure that the user's determined interests represent the user's current interests, the user's determined interests are discounted or weighted based at least in part on the times of the actions from which the respective interests were determined. For example, older actions are discounted more than recent actions. In some embodiments, the user's determined interests are discounted or weighted based at least in part on the type of action that the interest was determined from. The interests are weighted to reflect that some types of actions are better indicators of a user's interests. For example, an interest determined from a status message update may be more valuable than an interest determined from a user joining a group. The action interest extractor 120 determines a cumulative discount factor for each interest based on the weights and/or discounts applied to each interest. The cumulative discount factor for a respective interest measures the strength of the respective interest to the user. For example, a comparison of two cumulative discount factors would indicate which interest the user has a stronger affinity towards. As a result of the operations performed by the action interest extractor 120, a set of interests is determined for the user where each determined interest has an associated cumulative discount factor.

In some embodiments, the user's interests are determined responsive to receiving a request for a display page from the user. In some embodiments, the user's interests are determined periodically and retrieved when a user requests a display page.

A set of information items are identified and concepts associated with one or more of the information items are determined. The information item concept extractor 140 identifies 808 a set of information items from the ad store 130. In some embodiments, the information item concept extractor 140 requests a set of information items that target the user. For example, if the user is a 30 year old male living in California, the information item concept extractor 140 requests a set of information items from the ad server 230 that is targeted to a 30 year old male living in California.

The information item concept extractor 140 identifies 808 a plurality of concepts associated with each of the plurality of identified information items. In some embodiments, the information items are advertisements and concepts are determined from an advertisement based on a set of components of the advertisement comprising at least one of: a title of the advertisement, content of the advertisement, a tag associated with the advertisement, a link to content in the advertisement and targeting criteria for the advertisement. The information item concept extractor applies weights and/or discounts to the concepts based on the component that the concept was extracted from. For example, a tag of an advertisement may be more relevant to the advertisement than concepts extracted from the text of the advertisement. As a result of the operations of the concept extractor 140, each information item has a set of concepts where each concept has an associated cumulative discount factor.

In some embodiments, the concepts for the information items are determined responsive to receiving a request for a display page from the user. In some embodiments, the concepts for the information items are determined periodically and retrieved when a user requests a display page.

The fuzzy matcher 150 uses the determined user interests and the determined concepts for each of the information items to compute 810 a score for each of the information items. The fuzzy matcher 150 uses the information item scoring process 700 to score the information items. The score for each of the information items includes one or more contributions, each contribution based on matches of the determined interests and the determined concepts for the respective information item. In some embodiments, interests and concepts are matched based on the graph distance between the terms in a taxonomy. The closest interests and concepts within a predefined distance are matched. For example, the closest terms that are within four nodes of each other are selected. In some embodiments, interests and concepts are matched based on a relatedness factor between the two terms. The terms having the highest relatedness factor above a minimum threshold are matched. At least one match of an interest and a concept that may not be identical contributes to the score of an information item. For example, a user's interest of skiing may be matched to a concept of snowboarding. In some embodiments, the matched concept is discounted based on the distance between the concept and the interest in a taxonomy. In some embodiments, the concept is discounted based on the relatedness factor between the concept and the interest.

The fuzzy matcher 150 selects 812 one or more of the scored information items to display to the user. For example, the fuzzy matcher 150 may select the highest scored information items to display to the user. The fuzzy matcher 150 sends the one or more selected information items to the user for display. In some embodiments, the fuzzy matcher 150 sends the one or more selected information items to the display generator 220 which inserts the information items into a display page and sends the display page to the user. For example, the display generator 220 may insert the information items into a member profile page. The client 202 receives 814 the selected information items and the display page.

As a result of process 800, the user receives information items that are targeted to the user's interests. Some of the information items correspond to interests that are inferred from the user's interests. For example, a user may be provided with an information item related to snowboarding based on the user's interest in skiing, where the user's interests do not expressly indicate an interest in snowboarding.

In some embodiments, the action interest extractor 120 infers one or more additional interests from the determined interest using a taxonomy that identifies related terms. For example, the action interest extractor 120 may infer that a user likes hamburgers and soda based on a user's interest in a fast food restaurant. In some embodiments, a plurality of relatedness factors associated with each of the inferred additional interests is determined based on the extent to which the inferred interests relate to the determined interests. The inferred additional interests are discounted based at least in part on the associated relatedness factors. The inferred interests are compared with the concepts determined for each of the information items and one or more information items are selected based on the comparison. As discussed above, the fuzzy matcher 150 scores information items based on matches of interests and concepts, where the interests and the concepts do not need to be identical to be matched.

In some embodiments, one or more additional concepts are inferred for each of the information items using a taxonomy that identifies related terms. For example, the information item concept extractor 140 may infer the concepts of San Francisco and Los Angeles based on an extracted concept of California. In some embodiments, a plurality of relatedness factors associated with each of the additional concepts is determined based on the extent to which the additional concepts related to the determined concepts. The inferred additional concepts are discounted based at least in part on the associated relatedness factors. The fuzzy matcher 150 compares the determined interests for the user with the inferred additional concepts determined for each of the information items. One or more of the information items are selected based on the comparison of the inferred additional concepts. As discussed above, the fuzzy matcher 150 scores information items based on matches of interests and concepts, where the interests and the concepts do not need to be identical to be matched.

In some embodiments, actions of a plurality of connections of the user are observed by the action logger module 111. The action interest extractor 120 determines a plurality of interests for the connections of the user based on the observed actions. To ensure that the interests are current, a time decay factor is applied to the interests for the connections. In some embodiments, the plurality of interests is discounted based at least in part on an affinity of the user for the connection. For example, the interests of a connection that the user has a strong affinity for is scored higher than the interests of a connection that the user has a weak affinity for. The fuzzy matcher 150 computes a score for each of the information item, the score comprises one or more contributions, where each contribution is based on the determined interest of the connections and the determined concepts. As discussed above, the fuzzy matcher 150 scores information items based on matches of interests and concepts, where the interests and the concepts do not need to be identical to be matched. One or more information items are selected to display to the user. The selecting is based at least in part on the scores associated with the information items.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
observing actions of a user of a social networking system;
determining interests for the user based on the observed actions;
discounting the interests based at least in part on a time of the action from which the interest was determined;
receiving a plurality of information items for display to the user of the social networking system;
determining concepts associated with one or more of the plurality of information items; and
computing a score for each information item having an associated concept, the score comprising one or more contributions, each contribution based on matches of the determined interests and the determined concepts, wherein a match of a interest and a concept that are not identical contributes to the score;
selecting one or more of the information items to display to the user, the selecting based at least in part on the scores associated with the information items; and
sending the selected information items for display to the user.

2. The method of claim 1, further comprising:
inferring one or more additional interests from the determined interests using a taxonomy that identifies related terms; and
comparing the inferred interests with the concepts determined for each of the information items, wherein the one or more of the information items are selected based on the comparing of the inferred additional interests.

3. The method of claim 2, further comprising:
determining a plurality of relatedness factors associated with each of the inferred additional interests based on the extent to which the inferred interest relates to a determined interest in the taxonomy; and
discounting the inferred additional interests based at least in part on the associated relatedness factors.

4. The method of claim 1, further comprising:
inferring one or more additional concepts for each of the information items using a taxonomy that identifies related terms; and
comparing the determined interests for the user with the inferred additional concepts for each of the information items, wherein the one or more of the information items are selected based on the comparing of the inferred additional concepts.

5. The method of claim 4, further comprising:
determining a plurality of relatedness factors associated with each of the additional concepts based on the extent to which an additional concept relates to a determined concept in the taxonomy; and
discounting the inferred additional concepts based at least in part on the associated relatedness factors.

6. The method of claim 1, wherein the information items comprise advertisements.

7. The method of claim 6, wherein the concepts are determined from an advertisement based on a set of components of the advertisement comprising at least one of: a title of the advertisement, content of the advertisement, a tag associated with the advertisement, a link to content in the advertisement, and targeting criteria for the advertisement.

8. The method of claim 1, further comprising:
observing actions of a plurality of connections of the user of a social networking system;
determining interests for the connections of the user based on the observed actions;
discounting the determined interests for the connections based at least in part on a time of the action from which the interest for the plurality of connections was determined;
computing a score for each information item having an associated concept, the score comprising one or more contributions, each contribution based on matches of the determined interests for the connections and the determined concepts; and
selecting one or more of the information items to display to the user, the selecting based at least in part on the scores associated with the information items.

9. The method of claim 8, further comprising:
discounting the interests for each of the connections based at least in part on an affinity of the user for the connection.

10. The method of claim 1, further comprising:
discounting one or more of the interests based at least in part on a type of action performed in the action from which the interest was determined.

11. A system, comprising:
an action log containing a record of actions of the user of a social networking system;
an action interest extractor adapted to determine interests for the user based on the observed actions and discount the interests based at least in part on a time of the action from which the interest was determined;
an information item server adapted to receive a plurality of information items;
an information item concept extractor adapted to determine concepts associated with one or more of the plurality of information items; and
a selection module adapted to computing a score for each information item having an associated concept, the score comprising one or more contributions, each contribution based on matches of the interests for the member with the concepts for each information item, wherein a match of a interest and a concept that are not identical contributes to the score, and to select one or more of the information items to display to the member based on the computing.

12. The system of claim 11, further comprising a taxonomy for inferring one or more additional interests from the determined interests, and wherein the selection module is further configured to compare the inferred interests with the concepts determined for each of the information items and wherein the one or more of the information items are selected based on the comparing of the inferred additional interests.

13. The system of claim 12, wherein the taxonomy provides a plurality of relatedness factors associated with each of the inferred additional interests based on the extent to which the inferred interest relates to a determined interest in the taxonomy and wherein the inferred additional interests are discounted based at least in part on the associated relatedness factors.

14. The system of claim 11, further comprising a taxonomy for inferring one or more additional concepts for each of the information items using a taxonomy that identifies related terms, and wherein the fuzzy matcher is further configured to compare the interests determined for the member with the inferred additional concepts determined for each of the information items and wherein the one or more of the information items are selected based on the comparing of the inferred additional concepts.

15. The system of claim 14, wherein the taxonomy provides a plurality of relatedness factors associated with each of the additional concepts based on the extent to which an additional concept relates to a determined concept in the taxonomy and wherein the inferred additional concepts are discounted based at least in part on the associated relatedness factors.

16. The system of claim 11, wherein the fuzzy matcher is configured to match the user with each of the information items by producing a score for each information item and wherein the score for each information item is based on an overlap of the determined interests for the user and the determined concepts for the information item.

17. The system of claim 11, wherein the information items comprise advertisements.

18. The system of claim 11, wherein:
the action log further contains actions of a plurality of connections of the user of a social networking system, the action interest extractor is further adapted to determine interests for the connections of the user based on the observed actions and the interests for the connections based at least in part on a time of the action from which the interest for the plurality of connections was determined, and
the fuzzy matcher is further adapted to match the user with each of the information items by comparing the interests for the connections of the user with the concepts for each information item and select one or more of the information items to display to the user, the selecting based at least in part on the matching of the user with each of the information items by comparing the interests for the connections of the user.

19. The system of claim 18, further comprising an affinity predictor adapted to discount the plurality of interests for each of the connections based at least in part on an affinity of the user for the connection.

20. A computer program product having a non-transitory computer readable medium having a computer program embodied therein, the computer program comprising instructions for:
observing actions of a user of a social networking system;
determining interests for the user based on the observed actions;
discounting the interests based at least in part on a time of the action from which the interest was determined;
receiving information items for display to the user of the social networking system;
determining a plurality of concepts associated with one or more of the plurality of information items; and
computing a score for each information item having an associated concept, the score comprising one or more contributions, each contribution based on matches of the determined interests and the determined concepts, wherein a match of a interest and a concept that are not identical contributes to the score;
selecting one or more of the information items to display to the user, the selecting based at least in part on the scores associated with the information items; and
sending the selected information items for display to the user.
